(19) United States
(12) Patent Application Publication
(10) Pub. No.: US 2014/0076749 A1
(43) Pub. Date: Mar. 20, 2014

(54) VARIABLE DENSITY DESICCATOR HOUSING AND METHOD OF MANUFACTURING

(71) Applicants: Christopher L. Hernandez, Corona De Tucson, AZ (US); Jason R. Petty, Sahuarita, AZ (US)

(72) Inventors: Christopher L. Hernandez, Corona De Tucson, AZ (US); Jason R. Petty, Sahuarita, AZ (US)

(73) Assignee: Raytheon Company, Waltham, MA (US)

(21) Appl. No.: 13/617,945

(22) Filed: Sep. 14, 2012

(51) Int. Cl. B65D 81/26; B65D 6/00; B29C 35/08

(52) U.S. Cl. 206/204; 264/401; 220/660

(57) ABSTRACT

A desiccator housing is formed using a laser and selective laser sintering (SLS) process. The desiccator housing includes a first housing portion having a first wall thickness and a first permeability, and a second housing portion having a second wall thickness and a second permeability. A power of the laser is selected such that the first wall thickness provides the first permeability and the second wall thickness provides the second permeability.

### TECHNICAL FIELD

This disclosure is generally directed to desiccators. More specifically, this disclosure is directed to a variable density desiccator housing and a method of manufacturing thereof.

### BACKGROUND

Desiccators are sealable enclosures containing desiccant material and are used to absorb moisture in moisture-intolerant environments. One typical desiccator housing includes one or more sintered bronze filters bonded to injection molded bodies that are then bonded together to create an empty volume. Using fill ports, this volume is filled with desiccant material and sealed. Depending on the geometry of the desiccator housing, this process can require a substantial amount of touch labor.

### SUMMARY

This disclosure provides a variable density desiccator housing and a method of manufacturing thereof.

In a first embodiment, a desiccator housing is provided. The desiccator housing includes a first housing portion having a first wall thickness and a first permeability, and a second housing portion having a second wall thickness and a second permeability. The desiccator housing is formed using a laser and selective laser sintering (SLS) process, and a power of the laser is selected such that the first wall thickness provides the first permeability and the second wall thickness provides the second permeability.

In a second embodiment, a desiccator is provided. The desiccator includes a desiccant material and a desiccator housing containing the desiccant material. The desiccator housing includes a first housing portion having a first wall thickness and a first permeability, and a second housing portion having a second wall thickness and a second permeability. The desiccator housing is formed using a SLS process, and a power of the laser is selected such that the first wall thickness provides the first permeability and the second wall thickness provides the second permeability.

In a third embodiment, a method of forming a desiccator housing is provided. The method includes operating a laser in a SLS process to form a first housing portion of a desiccator housing, the first housing portion having a first wall thickness and a first permeability. The method also includes operating the laser in the SLS process to form a second housing portion of the desiccator housing, the second housing portion having a second wall thickness and a second permeability. A power of the laser is selected such that the first wall thickness provides the first permeability and the second wall thickness provides the second permeability.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates a desiccator housing formed through injection molding;

FIG. 2 illustrates an improved desiccator housing, according to an embodiment of this disclosure; and

FIG. 3 illustrates a method of manufacturing a desiccator, according to an embodiment of this disclosure.

### DETAILED DESCRIPTION

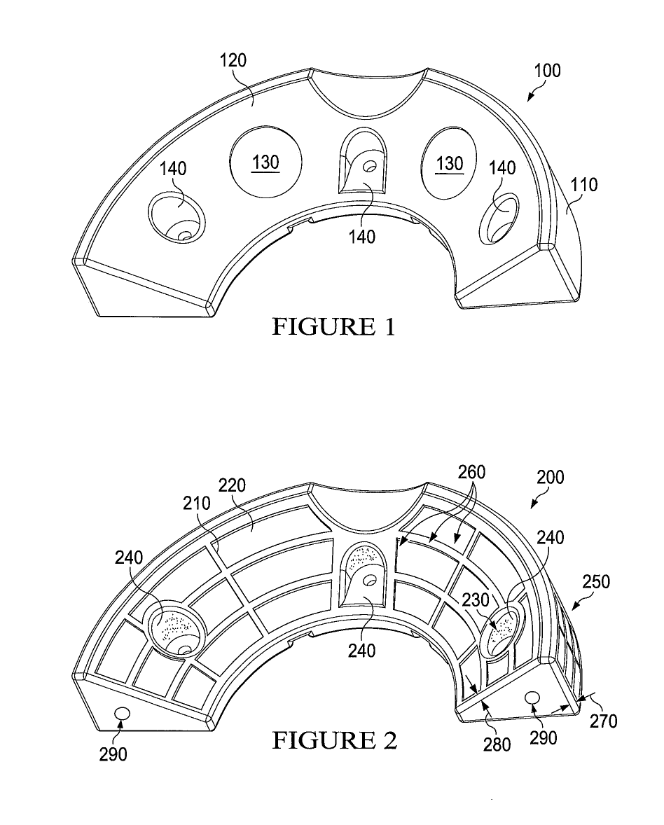

FIGS. 1 through 3, described below, and the various embodiments used to describe the principles of the present disclosure in this patent document are by way of illustration only and should not be construed in any way to limit the scope of the disclosure. Those skilled in the art will understand that the principles of the present disclosure may be implemented in any type of suitably arranged device or system.

This disclosure provides a novel desiccator housing that is quickly, easily, and inexpensively produced using Selective Laser Sintering (SLS). The desiccator housing and its method of manufacture represent a significant improvement over conventional desiccator housings.

A conventional desiccator housing assembly process includes multiple bonding steps and uses several components. First, plastic bodies are formed using injection molding. Later, sintered bronze filters are bonded to the injection-molded plastic bodies. Then, the plastic bodies are bonded together to create an empty volume. The volume is filled with desiccant material and sealed with a plug. Depending on the geometry of the desiccator housings, this process can involve a substantial amount of touch labor.

In contrast, the desiccator housing disclosed herein is manufactured using a Selective Laser Sintering (SLS) process that easily permits the housing wall thickness to vary, thereby varying the water vapor permeability of the desiccator housing. Likewise, density may be varied by changing the laser power used during the sintering process. This permeability can be adapted to meet the design standards of a given system, eliminating the need for sintered bronze filters. In addition, the SLS process can be used to create a single, hollow housing that does not need to be bonded together. The result is a desiccator housing that only needs to be filled with desiccant and sealed shut. This process significantly reduces cost by reducing the number of components, touch labor, assembly time, and non-recurring expense (NRE).

FIG. 1 illustrates a desiccator housing 100 formed through injection molding. The desiccator housing 100 includes a first housing part 110 and a second housing part 120. The two housing parts 110, 120 are injection molded separately and are bonded together to form an empty desiccator housing.

The desiccator housing 100 includes two sintered bronze filters 130 that control moisture permeation. Prior to bonding the two housing parts 110, 120 together, the sintered bronze filters 130 are bonded to the housing part 120. Once the two housing parts 110, 120 are bonded together, the empty volume is filled with desiccant material and a plug (not shown) is bonded to the housing to prevent leaks.

The desiccator housing 100 also includes a number of fastener holes 140 formed in the two housing parts 110, 120. The fastener holes 140 allow the desiccator housing 100 to be secured with one or more fasteners to a final assembly, such as a container, an electronics housing, and the like.

FIG. 2 illustrates an improved desiccator housing 200, according to an embodiment of this disclosure. Although certain details will be provided with reference to the components of the desiccator housing 200 of FIG. 2, it should be understood that other embodiments may include more, fewer, or different components.

The desiccator housing 200 is a substantially hollow housing having walls that define an interior space. The walls of the desiccator housing 200 vary in thickness. The desiccator housing 200 includes a plurality of first housing portions (hereinafter referred to as “ridges”), represented in FIG. 2 by the ridge 210. The desiccator housing 200 also includes a plurality of second housing portions (hereinafter referred to as “recesses”), represented in FIG. 2 by the recess 220. The ridges 210 have a greater cross-sectional wall thickness than the recesses 220. That is, the dimension from a given point on the exterior surface of the housing to the corresponding point on the interior surface is greater for the ridges 210 than for the recesses 220.

The desiccator housing 200 is formed as a single unit using a Selective Laser Sintering (SLS) process. As known in the art, SLS is a manufacturing process that uses a high power laser to fuse small particles of plastic, metal, ceramic, or other material into an object having a desired three-dimensional shape. In one embodiment, the desiccator housing 200 is formed from nylon particles or powder. It will be understood, however, that other suitable materials may be used to create the desiccator housing 200.

In SLS, the density of the manufactured object depends on the peak laser power; accordingly, the SLS process often uses a pulsed laser. The SLS process easily allows the wall thickness of the desiccator housing 200 to vary, thereby varying water vapor permeability through the housing. As the desiccator housing 200 is being formed in the SLS process, the laser may be programmed to cause variations in the thickness and permeability of selected surfaces of the housing. For example, in portions of the desiccator housing 200 where greater permeability is desired, a lower laser power is used to generate a thinner wall. In portions of the desiccator housing 200 where reduced permeability is desired, a higher laser power is used to generate a thicker wall.

In some SLS processes, the peak laser power is substantially the same throughout the sintering process. Accordingly, a peak laser power may be selected in advance to produce a sintered desiccator housing 200 with a desired density. The relationship between a particular laser power and a resulting density can be determined empirically at an earlier time. In other SLS processes, the peak laser power may be adjustable during the sintering process. In such situations, the SLS process may be configured to adjust the peak laser power during the sintering process, thereby varying the density across different parts of the desiccator housing 200.

As the desiccator housing 200 is being formed in the SLS process, an opening (not shown), such as a fill port, is provided in at least one wall to allow desiccant material to be added to the interior of the desiccator housing 200. After the desiccant material is added, the fill port may be closed or sealed with a plug or lid using known bonding techniques. The desiccator housing 200 may also include one or more fastener holes 240. The fastener holes 240 allow the desiccator housing 200 to be secured with one or more fasteners to a final assembly.

The recesses 220, which are the more porous surfaces of the desiccator housing 200, act as filters that allow water vapor outside the desiccator housing 200 to permeate through to the desiccant material inside the desiccator housing 200. Thus, the walls of the desiccator housing 200 act as filters, thereby eliminating the need for additional (e.g., sintered bronze) filters. The size, location, and permeability of the recesses 220 can be “tuned” to meet the absorption requirements and design standards of a given system.

The SLS process permits the desiccator housing 200 to be formed in a wide variety of shapes and sizes. The shape flexibility of the desiccator housing 200 allows a manufacturer to design an ideal assembly (e.g., an electronic device) with little regard as to whether and how a desiccator will fit into the assembly. In contrast, desiccator housings formed by injection molding are limited to certain shapes, dimensions, and tolerances. Manufacturers that use injection-molded desiccators in their assemblies must therefore consider the limitations of the injection-molded desiccators when designing their assemblies.

Although FIG. 2 illustrates one example of the desiccator housing 200, various changes may be made to FIG. 2. For example, the desiccator housing shown in FIG. 2 includes one arrangement of ridges 210 and recesses 220. In other embodiments, the ridges 210 and recesses 220 could include other shapes, sizes, quantities, and arrangements, and could include other porosities and thicknesses. For example, in some embodiments, every wall of the desiccator housing could be porous. In other embodiments, just selected walls could be porous, or just selected portions of certain walls could be porous. The determination of porous and non-porous walls and wall portions may depend on the arrangement and placement of the desiccator housing in an assembled package. For example, for a desiccator housing designed to fit against one or more walls in a corner or edge of an assembly, there may be no need to have the surfaces of the desiccator housing in contact with the walls be porous, because moisture may not capable of entering the desiccator housing along the contacted walls.

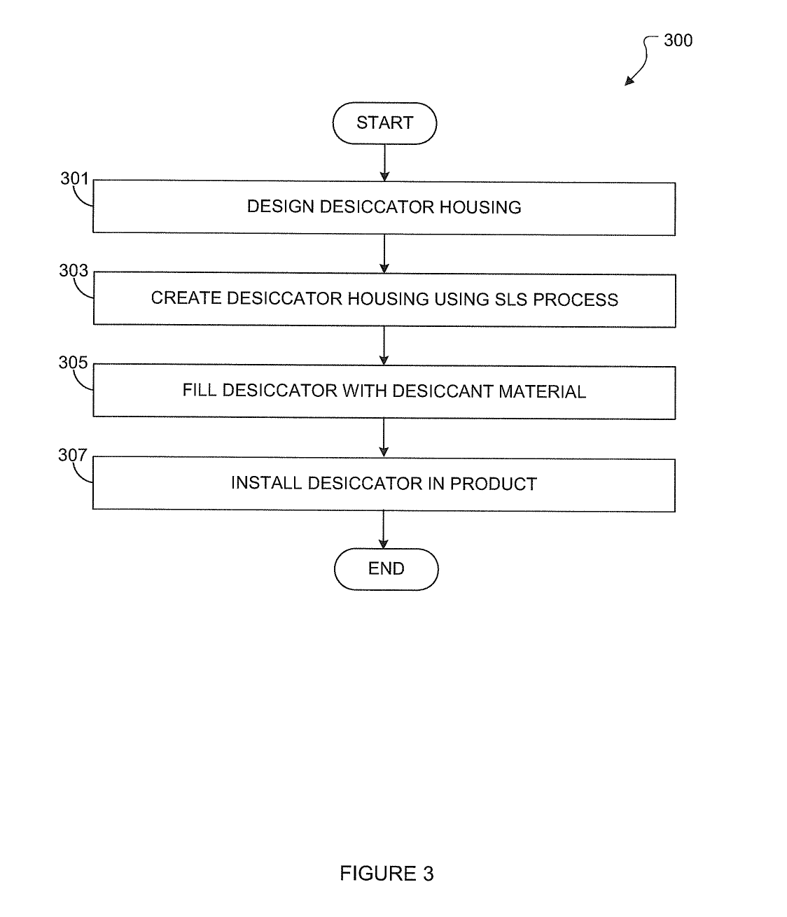

FIG. 3 illustrates a method 300 of manufacturing a desiccator, according to an embodiment of this disclosure. For ease of explanation, the method 300 is described with respect to the desiccator housing 200 of FIG. 2. The method 300 could be used with any other desiccator or desiccator housing.

Initially, at step 301, a desiccator housing is designed using, for example, a CAD application or other design tool. The resulting CAD file is provided to the SLS equipment.

At step 303, the SLS equipment creates a desiccator housing using the CAD file as an input. Based on the design of the desiccator housing in the CAD file, the SLS laser power is selected to provide a desired overall density and porosity. The sintering process is then performed to create wall portions of the desiccator housing that vary in thickness. For example, one housing portion could have a relatively greater thickness and reduced permeability, and another housing portion could have a relatively reduced thickness and greater permeability. In embodiments that feature a SLS laser power that is adjustable during the sintering process, the SLS laser power may be variously raised or lowered during the creation of the desiccator housing to create wall portions of the desiccator housing that vary in density and porosity, as well as thickness. The SLS equipment also provides an opening (fill port) in the desiccator housing.

At step 305, the finished desiccator housing is filled with desiccant material through the opening and the opening is sealed.

At step 307, the desiccator is installed in a product, container, package, or other assembly.

Although FIG. 3 illustrates one example of a method 300 for manufacturing a desiccator housing, various changes may be made to FIG. 3. For example, while shown as a series of steps, various steps shown in FIG. 3 could overlap, occur in a different order, occur in parallel, or occur multiple times. Moreover, some steps could be combined or removed, and additional steps could be added.

Studies have shown that, for desiccators manufactured using injection molding and having sintered bronze filters, over fifty percent of the desiccator's cost is from touch labor needed for assembly. In contrast, manufacturing a desiccator as described herein using SLS eliminates all but one bonding step (to seal the desiccant fill port) and all NRE. The SLS process also substantially reduces assembly times. As a result, use of the SLS process described herein to generate the desiccator housing may result in a cost savings of approximately 40% as compared to conventional methods.

In addition, the desiccator housing can be manufactured without knowledge of injection molding, sintered bronze filters, bonding of multiple parts, or adhesive surface prep techniques. A supplier can simply “grow” the housing using SLS, fill it with desiccant, and the finished desiccator is ready to be delivered to a customer. New or altered housings can be designed, grown, and delivered in one day.

Embodiments of the disclosed desiccator housing can be used in any application where water vapor permeation needs to be controlled using a rigid body. These applications occur in both commercial and non-commercial designs. Example uses include desiccators for seekers, optics, electronics, biomedical devices, RF technology, and in any other moisture-intolerant environments.

It may be advantageous to set forth definitions of certain words and phrases used throughout this patent document. The teens “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A desiccator housing, comprising:
a hollow structure with a plurality of walls, the walls comprising:
a first housing portion having a first wall thickness and a first permeability; and
a second housing portion having a second wall thickness and a second permeability,
wherein the desiccator housing is formed using a laser and selective laser sintering (SLS) process, and a power of the laser is selected such that the first wall thickness provides the first permeability and the second wall thickness provides the second permeability.

2. The desiccator housing of claim 1, wherein the first wall thickness is greater than the second wall thickness, and the first permeability is less than the second permeability.

3. The desiccator housing of claim 1, wherein the second permeability is relatively high such that the second housing portion is configured to act as a filter for the desiccator housing, and the first permeability is relatively low such that the first housing portion is not configured to act as a filter.

4. The desiccator housing of claim 1, wherein the first wall thickness is achieved using a higher laser power during the SLS process than a laser power used to achieve the second wall thickness.

5. The desiccator housing of claim 1, wherein the first housing portion comprises a plurality of ridges and the second housing portion comprises a plurality of recesses.

6. The desiccator housing of claim 1, the desiccator housing further comprising at least one fastener hole configured to accept a fastener to secure the desiccator housing to an assembly.

7. The desiccator housing of claim 1, the desiccator housing further comprising an opening that enables a desiccant material to be inserted inside the desiccator housing.

8. A desiccator, comprising:
a desiccant material; and
a desiccator housing containing the desiccant material, the desiccator housing comprising:
a hollow structure with a plurality of walls, the walls comprising:
a first housing portion having a first wall thickness and a first permeability;
and
a second housing portion having a second wall thickness and a second permeability,
wherein the desiccator housing is formed using a laser and selective laser sintering (SLS) process, and a power of the laser is selected such that the first wall thickness provides the first permeability and the second wall thickness provides the second permeability.

9. The desiccator of claim 8, wherein the first wall thickness is greater than the second wall thickness, and the first permeability is less than the second permeability.

10. The desiccator of claim 8, wherein the second permeability is relatively high such that the second housing portion is configured to act as a filter for the desiccator housing, and the first permeability is relatively low such that the first housing portion is not configured to act as a filter.

11. The desiccator of claim 8, wherein the first wall thickness is achieved using a higher laser power during the SLS process than a laser power used to achieve the second wall thickness.

12. The desiccator of claim 8, wherein the first housing portion comprises a plurality of ridges and the second housing portion comprises a plurality of recesses.

13. The desiccator of claim 8, the desiccator housing further comprising at least one fastener hole configured to accept a fastener to secure the desiccator housing to an assembly.

14. The desiccator of claim 8, the desiccator housing further comprising an opening that enables the desiccant material to be inserted inside the desiccator housing.

15. (Currently Withdrawn) A method of forming a desiccator housing, comprising:
operating a laser in a selective laser sintering (SLS) process to form a first housing portion of a desiccator housing, the first housing portion having a first wall thickness and a first permeability; and
operating the laser in the SLS process to form a second housing portion of the desiccator housing, the second housing portion having a second wall thickness and a second permeability,
wherein a power of the laser is selected such that the first wall thickness provides the first permeability and the second wall thickness provides the second permeability.

16. The method of claim 15, wherein the first wall thickness is greater than the second wall thickness, and the first permeability is less than the second permeability.

17. The method of claim 15, wherein the second permeability is relatively high such that the second housing portion is configured to act as a filter for the desiccator housing, and the first permeability is relatively low such that the first housing portion is not configured to act as a filter.

18. The method of claim 15, wherein the first wall thickness is achieved using a higher laser power during the SLS process than a laser power used to achieve the second wall thickness.

19. The method of claim 15, wherein the first housing portion comprises a plurality of ridges and the second housing portion comprises a plurality of recesses.

20. The method of claim 15, further comprising:
operating the laser in the SLS process to provide at least one fastener hole in the desiccator housing, the at least one fastener hole configured to accept a fastener to secure the desiccator housing to an assembly.
